(19) United States
(12) Patent Application Publication
(10) Pub. No.: US 2025/0154975 A1
(43) Pub. Date: May 15, 2025

(54) SMART TOGGLE BOLT

(71) Applicant: SGU Tech Co.,LTD, Hwaseong-si (KR)

(72) Inventor: Sang-Kon You, Hwasung-si (KR)

(21) Appl. No.: 18/507,101

(22) Filed: Nov. 13, 2023

(51) Int. Cl. F16B 13/08

(52) U.S. Cl. CPC F16B 13/0808

(57) ABSTRACT

Provided is a smart toggle bolt for fastening structures to each other in semiconductors or display processing lines, including a bolt main body, which is inserted into through holes formed in a structure and a bracket and has a thread formed in a longitudinal direction, a height adjustment bolt, which is formed with a thread in a longitudinal direction of a body, adjusts height by being threaded to the inside of the bolt main body, and has an adjustment pin insertion groove formed in the longitudinal direction on one side, a toggle member, which is coupled to the bolt main body and rotates around a rotation shaft, and an unlocking adjustment pin, which is inserted along the adjustment pin insertion groove of the height adjustment bolt and rotates the toggle member so that the toggle member axially rotates around the rotation shaft to unlock the bracket from the structure.

### BACKGROUND OF THE INVENTION

### Technical Field

The present invention relates to a smart toggle bolt and, more specifically, to a smart toggle bolt which can firmly fasten structures to each other in a semiconductor or display processing line.

### Background

A toggle bolt is an anchor (foundation) bolt with hinged wings that open with a spring, wherein if the wings are inserted into a through hole formed in a structure in a folded state and then passes through the through hole, the wings are spread and act as a nut, thereby firmly securing the bolt to the structure by the wings.

However, the conventional toggle bolts have problems in that one pair of wing parts are folded by a spring and the spring is structurally made of thin steel wire so that the spring is easily deformed and consequently weaken the durability of the toggle bolt.

Due to the structural limitations, even if the bolts are installed on a structure, binding force may be reduced, resulting in safety problems.

Meanwhile, the background technology mentioned above is technical information that the present inventor has possessed to derive the present invention or acquired in the process of deriving the present invention, and cannot necessarily be said to be known technology disclosed to the general public before filing the application for the present invention.

### PRIOR ART DOCUMENT

### Patent Document

KR 10-2008-0020248
KR 10-0499680

### DISCLOSURE OF THE INVENTION

### Technical Problem

Therefore, the present invention was created to solve the problems described above, and its purpose is to provide a smart toggle bolt, in which when installing the smart toggle bolt to be fastened to a structure, a part of the bolt that protrudes from a rear surface of a front surface where the bolt is inserted can be firmly secured to the rear surface without a separate nut fastening process. However, the objects of the present invention are not limited to the object mentioned above, and other objects not mentioned will be clearly understood by those skilled in the art from the description below.

### Technical Solutions

The purpose of the present invention described above can be achieved by providing a smart toggle bolt used to fix a bracket to a structure, including a bolt main body inserted into through holes formed in a structure and a bracket, a toggle member fastened to a lower end of the bolt main body so as to rotate eccentrically, a housing fastened to the lower end of the bolt main body so as to slidingly move in a longitudinal direction of the lower end, and a rotation shaft, which is biased to one side based on a long axis of the bolt main body so as to be formed eccentrically, wherein according to sliding movement of the housing, the toggle member rotates eccentrically by the rotation shaft, alternating or toggling between a locked state and an unlocked state so as to secure the bracket to the structure.

In addition, the bolt main body includes a cylindrical upper end portion, a middle portion, which extends from the upper end portion and has a thread formed on an outer peripheral surface, and a cylindrical lower end portion, which extends from the middle portion, has a sliding slit formed on at least one side in a longitudinal direction of the body so that a cross-section is formed in a U-shape open to the right, and has a diameter larger than those of the upper end portion and the middle portion.

Furthermore, the housing includes a cylindrical housing main body fastened to the outside of the lower end portion, and a locking member, which extends from one side of the lower end of the housing main body, of which a portion is inserted inside the sliding slit and moves along the sliding slit so as to press one surface of the toggle member, and which restricts movement of the housing in one direction.

Meanwhile, the toggle member is provided in a trapezoidal shape such that length of an upper side is equal to diameter of the lower end portion, length of a lower side is greater than the diameter of the lower end portion, and height is equal to the diameter of the lower end portion, and has a hole formed in the center so as to be axially coupled to the rotation shaft through the through hole, the upper side is positioned inside the bolt main body according to the eccentric arrangement of the rotation shaft, and the lower side passes through the sliding slit and is positioned outside the bolt main body.

In addition, if the housing is in a lowered state, the toggle member is pressed by the locking member that comes into contact with the upper side of the toggle member so that the upper side and the lower side are fixed in a direction parallel to the longitudinal direction of the bolt main body so as to maintain the unlocked state, and as the housing rises, pressing restraint force of the locking member that is in contact with the upper side is gradually weakened and the toggle member is rotated by the rotation shaft so that the upper side and the lower side are spread in a direction perpendicular to the longitudinal direction of the bolt main body so as to maintain the locked state. Furthermore, when the locking member has risen to maximum height and comes into contact with an inner surface of the sliding slit, the pressing restraint force by the locking member is released and the upper side and the lower side of the toggle member are spread in the direction perpendicular to the longitudinal direction of the bolt main body so as to maintain the locked state. Moreover, the toggle member has a trapezoidal shape in which both hypotenuses formed between the upper side and the lower side are formed to have stepped inclination structures and anti-slip members are provided on surfaces of the stepped inclination structures.

Meanwhile, the objectives of the present invention can be achieved by providing a smart toggle bolt, including a bolt main body, which is inserted into through holes formed in a structure and a bracket and has a thread formed in a longitudinal direction, a height adjustment bolt, which is formed with a thread in a longitudinal direction of a body, adjusts height by being threaded to the inside of the bolt main body, and has an adjustment pin insertion groove formed in the longitudinal direction on one side, a toggle member, which is coupled to the bolt main body and rotates around a rotation shaft, and an unlocking adjustment pin, which is inserted along the adjustment pin insertion groove of the height adjustment bolt and rotates the toggle member so that the toggle member axially rotates by the rotation shaft so as to unlock the bracket from the structure.

### Advantageous Effects of the Invention

According to the present invention as described above, even if a nut is not tightened to the back of a structure so as to fasten the smart toggle bolt, the diameter (width) of the toggle member expands as the smart toggle member rotates so that the smart toggle bolt can be firmly fastened to the structure. In addition, the toggle member can be spread or folded with a simple operation, thereby improving ease of installation.

### BRIEF DESCRIPTION OF DRAWINGS

The following drawings attached herein illustrate preferred embodiments of the present invention, and serve to further understand the technical idea of the present invention along with the detailed description of the invention. Therefore, the present invention should not be construed as limited to only the matters described in such drawings.

FIG. 1 is a view showing schematic configuration of a smart toggle bolt according to a first embodiment of the present invention,

FIGS. 2(a) and 2(b) are side views of the toggle bolt according to the first embodiment of the present invention,

FIGS. 3(a) and 3(b) are views for showing specific configuration of a housing according to the first embodiment of the present invention,

FIGS. 4(a) and 4(b) are views for explaining operating principle of the toggle bolt according to the first embodiment of the present invention,

FIGS. 5(a), 5(b), 5(c) and 5(d) are views for showing specific fastening process of the toggle bolt according to the first embodiment of the present invention,

FIG. 6 is a view for showing schematic configuration of a smart toggle bolt according to a second embodiment of the present invention,

FIG. 7 is a view for showing schematic configuration of a smart toggle bolt according to a third embodiment of the present invention, and

FIGS. 8 to 10 are views for showing schematic configuration of a smart toggle bolt according to a fourth embodiment of the present invention.

### MODE FOR INVENTION

Hereinafter, preferred embodiments of the present invention will be described with reference to the drawings. In addition, the embodiments described below do not unduly limit the content of the present invention described in the claims, and it cannot be said that the entire configuration described in the embodiments is essential as a solution of the present invention. In addition, explanations may be omitted for matters that would be obvious to those skilled in the art and prior art may be omitted, and description of these omitted components (methods) and functions may be sufficiently referenced without departing from the technical spirit of the present invention.

### First Embodiment

Hereinafter, a first preferred embodiment of the present invention will be described in detail with reference to the accompanying drawings.

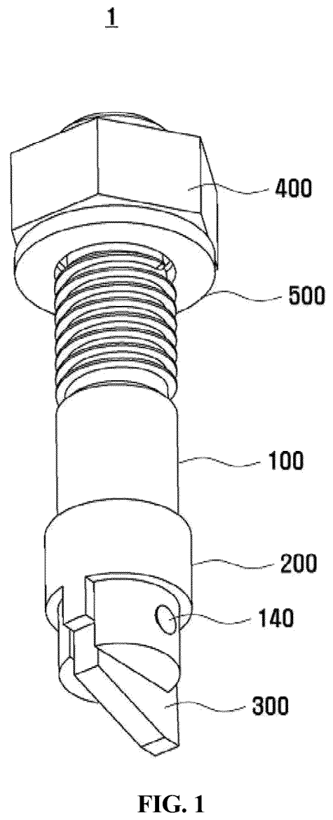

FIG. 1 is a view showing schematic configuration of a smart toggle bolt according to a first embodiment of the present invention. A smart toggle bolt 1 according to the present invention is used to fix a bracket to a structure. As an example, the structure may be a semiconductor production facility, and the bracket may be a panel-shaped member that can perform dust-proof function of the semiconductor production facility. That is, the smart toggle bolt 1 according to the present invention may be an anchor unit used to firmly fix a bracket to a semiconductor production facility in order to improve the dust-proof function of the semiconductor production facility.

However, applications of the smart toggle bolt 1 are not limited to the above-mentioned example, and as long as the smart toggle bolt 1 is used to bind two different structures together, there are no restrictions on the usage environment, including semiconductor process as well as display process.

Specifically, the smart toggle bolt 1 according to the first embodiment of the present invention includes a bolt main body 100, a housing 200, a toggle member 300 and a nut 400. Additionally, a washer 500 may be further included as necessary so as to prevent damage to the nut 400 before fastening the nut 400 to the bolt main body 100.

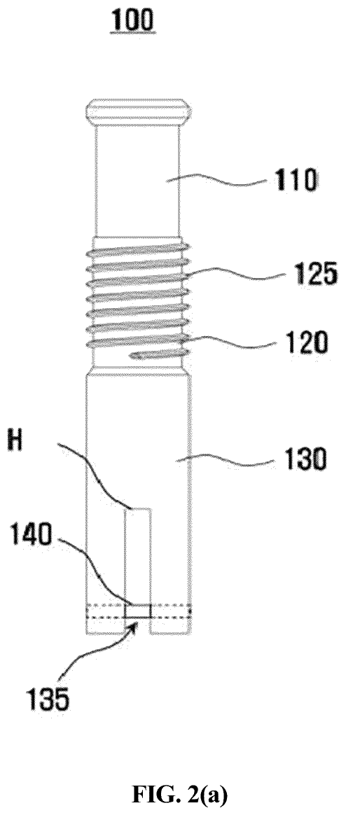

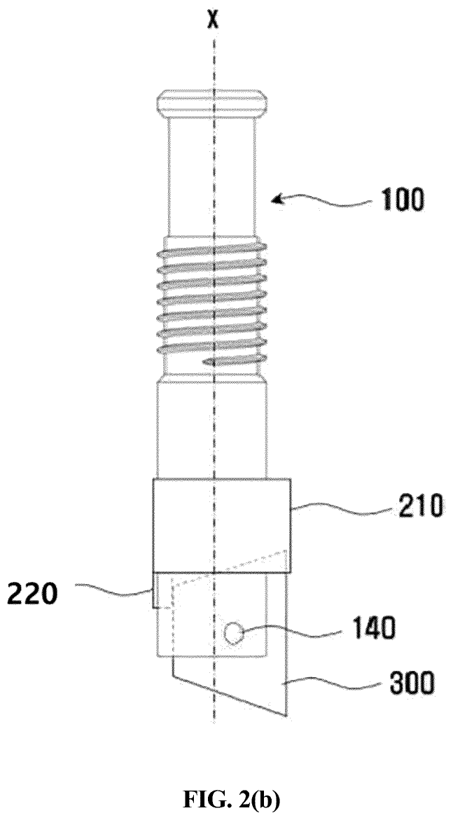

The bolt main body 100 is a headless bolt to be inserted into a through hole formed in a structure to be installed, and is composed of a cylindrical upper end portion 110, a middle portion 120, which extends from the upper end portion 110 and has a thread 125 formed on an outer peripheral surface, and a cylindrical lower end portion 130, which extends from the middle portion 120 and has a diameter larger than diameters of the upper end portion 110 and the middle portion 120, as shown in FIG. 2(a).

Herein, the lower end portion 130 has a groove formed in a longitudinal upward direction on the inside of an end portion of a lower surface. Hereinafter, for convenience of explanation, the groove formed on the lower end portion 130 is defined as a sliding slit 135.

The sliding slit 135 is formed for a predetermined length in the longitudinal direction of the lower end portion 130 toward the upper direction from the end of the lower end portion 130, as shown in FIG. 2(a). Accordingly, sliding slits 135 are formed in the longitudinal direction on both sides of the lower end portion 130.

One side sliding slit 135 allows a locking member 220 to move up and down, and the other sliding slit 135 allows a lower side of the toggle member 300 to pass through the other sliding slit 135 and be exposed to the outside. In addition, the toggle member 300 can rotate through the both side sliding slits 135.

The locking member 220 moves up and down along the sliding slit 135. By the sliding slits 135, straight grooves are formed on the lower end portion 130. It is preferable that length of the sliding slits 135 be longer than length of the lower side of the toggle member 300, which will be described later. Therefore, the lower end portion 130 has a cross-section formed in a U-shape (or “L”-shape) due to the sliding slits 135, and an opening part is formed by the sliding slits 135 at a portion of an outer circumferential surface of the lower end portion 130. A rotation shaft 140 is provided in a horizontal direction on inner surfaces of one pair of opposing sliding slits 135 so as to fasten the toggle member 300 and the lower end portion 130 of the housing 100 to each other. Therefore, eccentric through holes are formed in the lower end portion 130 of the housing 100, and the toggle member 300 is rotatably fastened by predetermined fastening members through the through holes of the lower end portion 130 and the through hole of the toggle member 300.

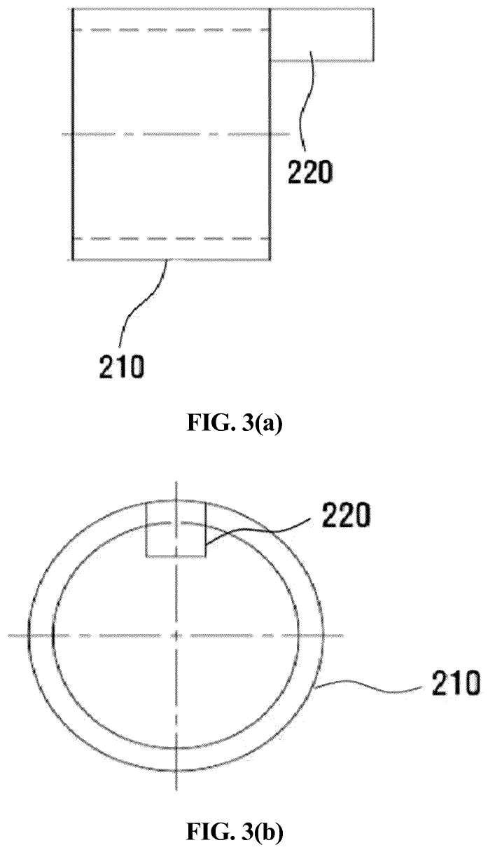

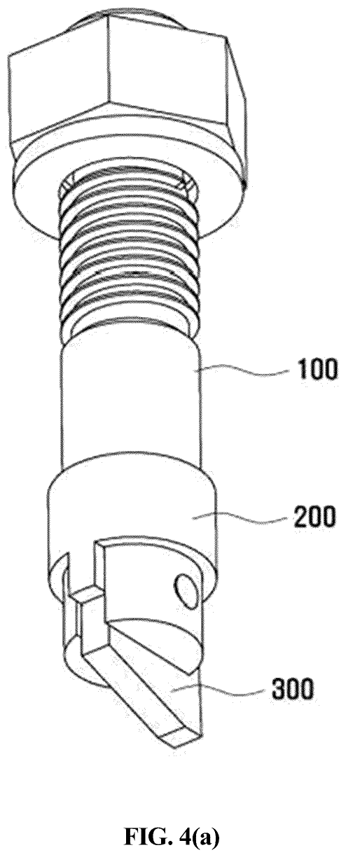

The housing 200 is a cylindrical member, which is fastened to the lower end portion 130 of the bolt main body 100 and slides in the longitudinal direction of the lower end portion 130. Specifically, referring to FIG. 2(a) to FIG. 3(b), the housing 200 includes a cylindrical housing main body 210 fastened to the outside of the lower end portion 130, and the locking member 220 extending downward from one side of a lower end of the housing main body 210, wherein the locking member 220 has a rectangular shape (“□” shape) and is partially inserted along the longitudinal direction of the sliding slit 135, as shown in FIGS. 2(b) and 3(b). Herein, it is preferable that thickness of the locking member 220 is greater than thickness of the housing main body 210, wherein when the locking member 220 is viewed lying down as shown in FIG. 3(a), an upper portion of the locking member 220 is formed to be exposed to the outside together with the housing body 210, and a lower portion of the locking member 220 can be fastened to the bolt body 100 while being inserted inside the sliding slit 135.

Accordingly, the housing 200 can slide and move up and down in the longitudinal direction of the bolt main body 100. The housing 200 has no restrictions on movement in the downward direction of the bolt main body 100, but can only move up to a position where the locking member 220 comes into contact with a bottom surface H of the sliding slit 135 in the upward direction of the bolt main body 100.

The toggle member 300 is coupled to the rotation shaft 140 while being fitted into the sliding slits 135 in the longitudinal direction of the sliding slits 135. The toggle member 300 has a trapezoidal shape such that length of an upper side of the toggle member 300 is equal to the diameter of the lower end portion 130, the length of the lower side is greater than the diameter of the lower end portion 130, and height is equal to the diameter of the lower end portion 130.

The toggle member 300 has a through hole formed in the center for the fastening of the rotation shaft 140 so that the toggle member 300 is axially coupled to the rotation shaft 140 through the through hole.

At this time, when the sliding slits 135 are viewed from the side as shown in FIG. 2(b), a rotation shaft 140 is biased to one side based on a long axis x of the bolt main body 100 so as to be formed eccentrically. Therefore, the upper side of the toggle member 300 according to the present invention is positioned inside the lower end portion 130 of the bolt main body 100 through the sliding slits 135, and the lower side is eccentrically coupled so as to be exposed to the outside of the lower end portion 130 of the bolt main body 100 through the sliding slits 135. The toggle member 300 is eccentrically and axially coupled to the rotation shaft 140 based on the long axis x of the bolt main body 100, since the rotation shaft 140 is biased to one side based on the long axis x of the bolt main body 100.

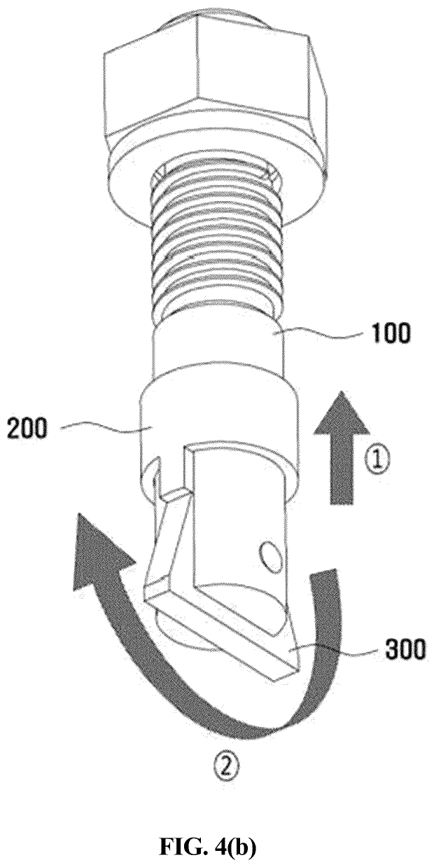

Referring to FIG. 4(a), the locking member 220, which is partially inserted into the inside of the bolt main body 100 in the longitudinal direction of the sliding slit 135, comes into surface contact with the upper side of the toggle member 300, thereby pressing the toggle member 300. Referring to FIG. 4(b), since the locking member 220 and the upper side of the toggle member 300 are in surface contact with each other and pressurize each other, when the housing 200 is moved upward, pressing force gradually weakens so that the toggle member 300 rotates. The structure and the bracket can be locked to (or unlocked from) by rotating the toggle member 300. It is preferable that length of the locking member 220 is set to a length that allows the toggle member 300 to fully rotate by sufficiently pressing the upper side of the toggle member 300 when the housing 200 is lowered (when switching from the locked state to the unlocked state).

The nut 400 may be inserted into the bolt main body 100 through the upper end portion of the bolt main body 100 and bolted to the bolt main body 100 through the thread 125 formed on the middle portion 120.

The operation principle of the smart toggle bolt 1 according to the first embodiment of the present invention as described above will be explained with reference to FIGS. 4(a) and 4(b). Referring to FIG. 4(a), when the housing 200 is in a lowered state, the toggle member 300 is pressed by the locking member 220 that comes into surface contact with the upper side of the toggle member 300 so that the upper side and the lower side are maintained in a fixed state in a direction parallel to the longitudinal direction of the bolt main body 100 (unlocked state of toggle member).

After that, referring to FIG. 4(b), if the housing 200 gradually rises, pressing force of the locking member 220 that is in surface contact with the upper side of the toggle member 300 is gradually weakened and accordingly the toggle member 300 rotates in the clockwise or counterclockwise direction by the rotation shaft 140 (locked state).

If the locking member 220 has risen to maximum height H so that an upper surface of the locking member 220 comes into contact with one inner surface of the sliding slit 135 due to rise of the housing 200, pressing restraint force by the locking member 220 is completely released and the upper side and the lower side of the toggle member 300 are spread in the direction perpendicular to the longitudinal direction of the bolt main body 110, thereby switching from the unlocked state to the locked state.

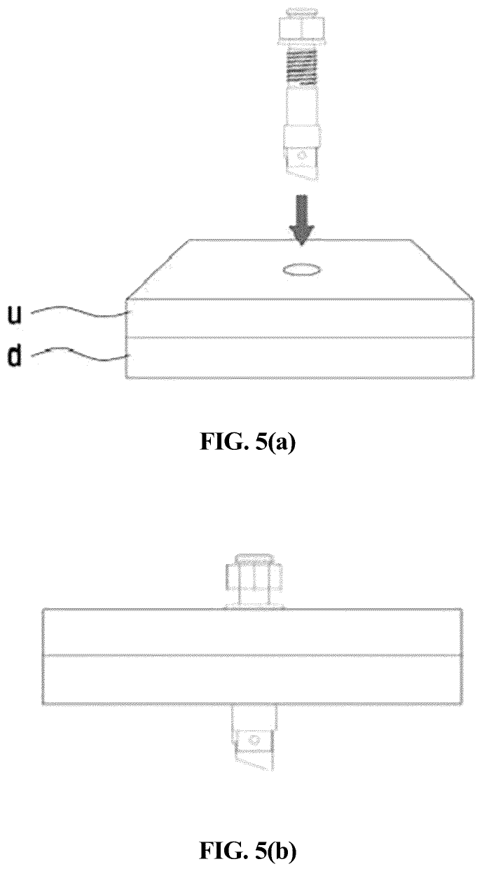

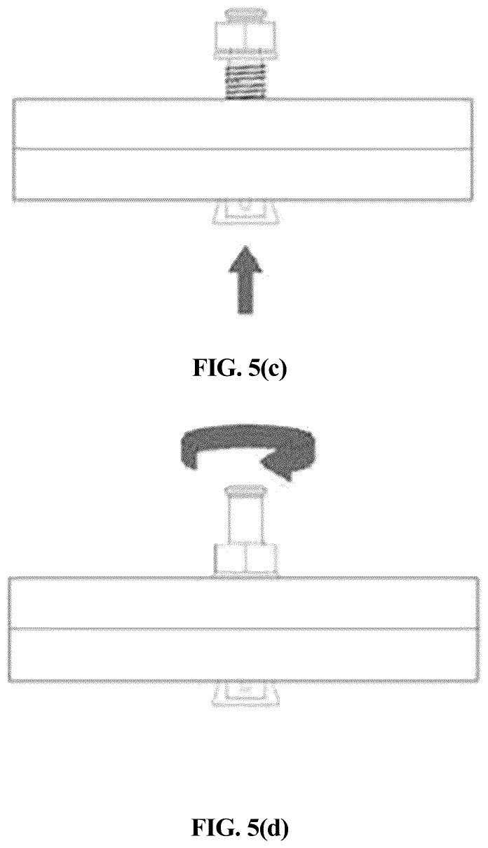

Meanwhile, process of fastening structures u, d by using the smart toggle bolt 1 described above is as follows. Referring to FIG. 5(a), when binding an upper structure u and a lower structure d together, a worker first inserts the smart toggle bolt 1 into through holes commonly formed in the upper structure u and the lower structure d.

Referring to FIG. 5(b), when the smart toggle bolt 1 is inserted into the through holes of the structures, the housing 200 comes into contact with (or frictions with) inner walls of the through holes of the structures and naturally rises in the upward direction of the bolt main body 110. Alternatively, with the smart toggle bolt 1 fully inserted into the through holes of the structures, the housing 200 can be pushed upward so that the housing 220 is induced to rise in the upward direction of the bolt main body 110.

Referring to FIG. 5(c), when the housing 200 is fully raised, the toggle member 300, which is not spread in the unlocked state, rotates and is spread to the locked state. Accordingly, both hypotenuses of the toggle member 300 come into contact with the lower structure d.

Referring to FIG. 5(d), the upper structure u and the lower structure d are firmly coupled by the toggle bolt 1 by fastening the nut 400.

### Second Embodiment

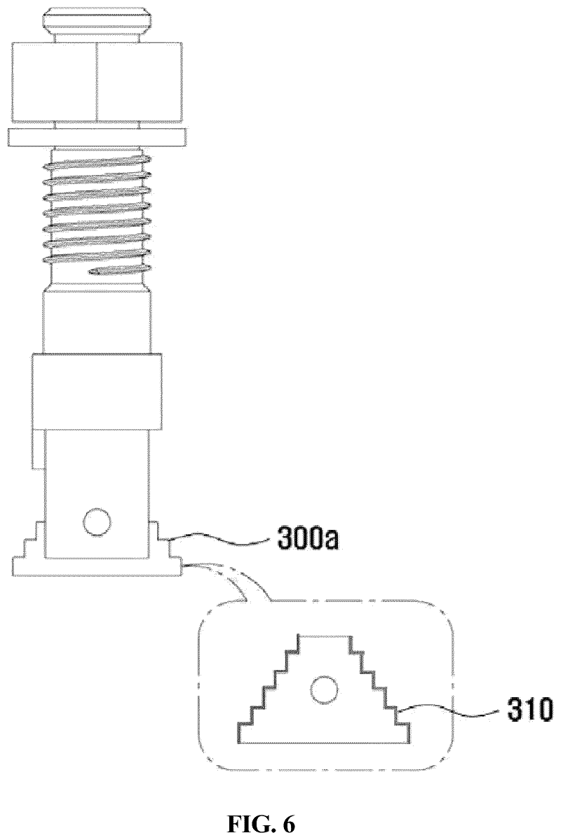

As shown in FIG. 6, the smart toggle bolt according to a second embodiment of the present invention has the same structure and function as those of the first embodiment described above, except that a toggle member 300a having stepped inclination structures is provided.

The toggle member 300a has the stepped inclination structures on both hypotenuses formed between an upper side and a lower side, wherein surfaces of the stepped inclination structures are provided with anti-slip members 310, such as rubber or silicone, so as to maximize friction between the toggle member 300a and a structure.

### Third Embodiment

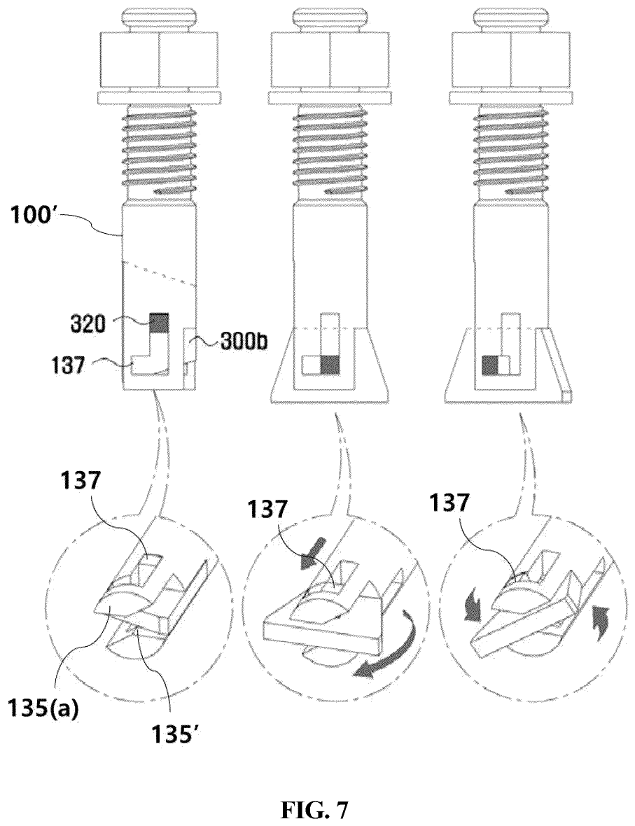

FIG. 7 shows a smart toggle bolt according to a third embodiment of the present invention.

Compared to the toggle bolt according to the first embodiment of the present invention as shown in FIG. 1, the toggle bolt according to the third embodiment of the present invention is different in that the housing 200 is omitted and a lower end portion 130 of the bolt main body 100 and the toggle member 300 are modified in shape.

A bolt main body 100′ has a sliding slit 135′ and an “L”-shaped guide slit 137 formed in a lower end portion, wherein the “L”-shaped guide slit 137 guides movement of a toggle member 300b. In addition, the sliding slit 135′ is an arc-shaped groove rather than a straight groove, and an end of a lower end portion of the bolt main body 100′ has an arc shape 135a by the sliding slit.

In addition, a vertical protruding member 320 is formed on a front surface of the toggle member 300b. The protruding member 320 moves along the guide slit 137. The smart toggle bolt is in an unlocked state with an upper side and a lower side of a toggle member 300 which are horizontal to the longitudinal direction of the bolt main body 100′, and when the toggle member 300 lowers, the upper side and the lower side are spread in a direction perpendicular to the longitudinal direction of the bolt main body 100, thereby maintaining a locked state.

When a worker rotates the bolt main body 100′ while the toggle member 300b is spread and is in contact with a structure, the toggle member 300 moves to a left end portion of an “L”-shaped structure of the guide slit 137, and accordingly, the toggle member 300b is twisted in the spread state so that the spread state is locked [locked state].

### Fourth Embodiment

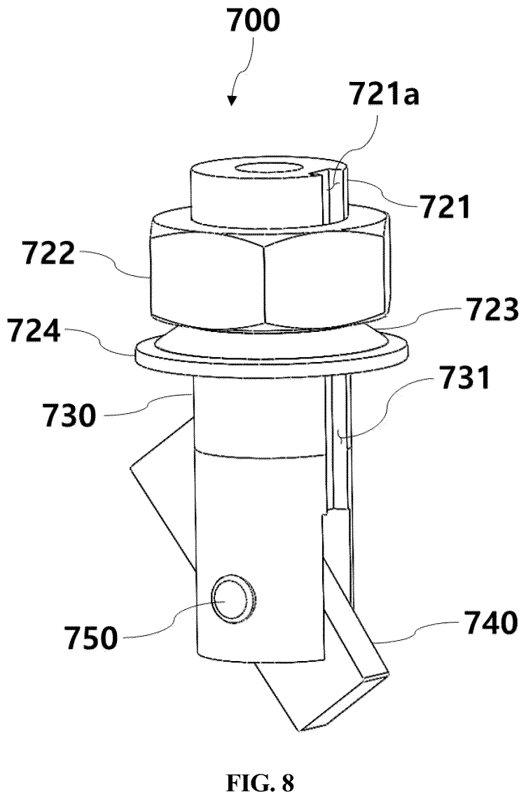

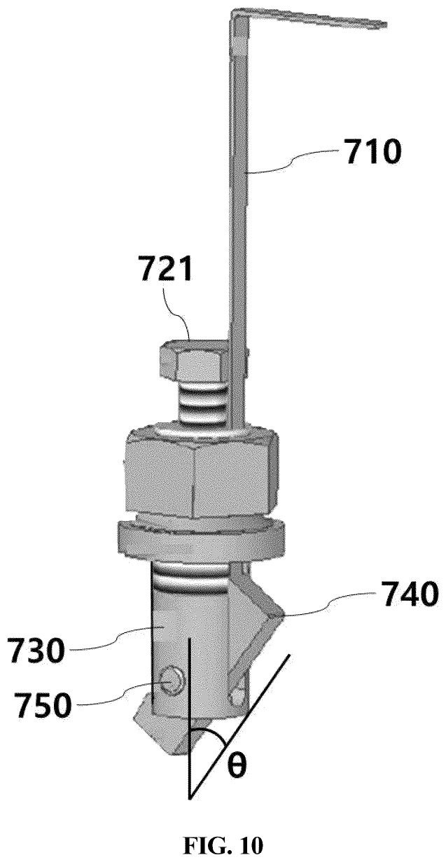

A smart toggle bolt 700 according to a fourth embodiment of the present invention will be described with reference to FIG. 8 to FIG. 10.

The smart toggle bolt 700 generally includes a height adjustment bolt 721, a nut 722, a spring washer and a flat washer 723, 724, a bolt main body 730, a toggle member 740 and a rotation shaft 750.

The height adjustment bolt 721 has a thread formed in a longitudinal direction of a body, and is threaded to the inside of the bolt main body 730 so as to adjust overall height of the smart toggle bolt 700. In other words, coupling length of the height adjustment bolt 721 and the bolt main body 730 can be adjusted as much as possible according to height of a structure and a bracket, thereby achieving maximum close coupling.

An adjustment pin insertion groove 721a is formed on one side surface of the height adjustment bolt 721 in the longitudinal direction. The unlocking adjustment pin 710 is inserted into the adjustment pin insertion groove 721a. The adjustment pin insertion groove may be partially formed in the longitudinal direction not only on one side surface of the height adjustment bolt 721 but also on one side surface of the bolt main body 730 as necessary.

Fastening height of the nut 722 is adjusted and the smart toggle bolt 700 is jointed. The spring washer and the flat washer 723, 724 are inserted into the bolt main body 730 under the nut 722 so as to prevent loosening after fastening.

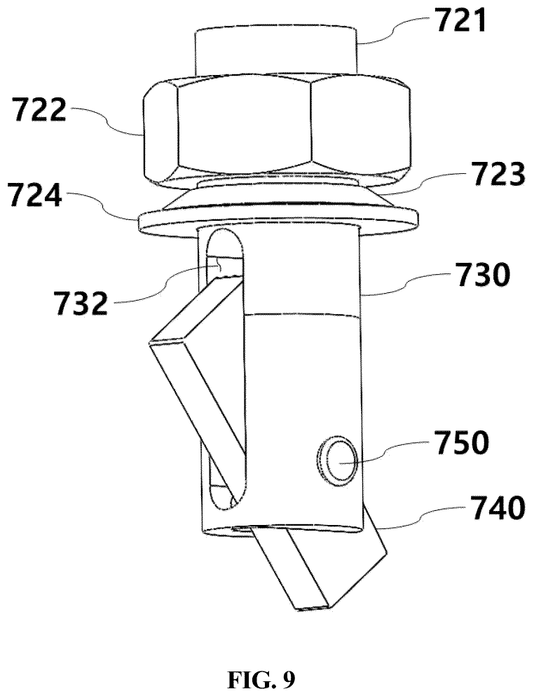

The bolt main body 730 is formed with threads at least in part in the longitudinal direction from top to bottom, and the height adjustment bolt 721 is threaded to the inside of the bolt main body 730. On both side surfaces of the bolt main body 730, first and second rotation slits 731, 732 are formed in the longitudinal direction so that the toggle member 740 can rotate based on the rotation shaft 750. As an example, the first rotation slit 731 may be formed on the right side, and the second rotation slit 732 may be formed on the left side. The first rotation slit 731 is formed entirely in the longitudinal direction on the right side surface of the bolt main body 730 so that the toggle member 740 can rotate, and the second rotation slit 732 is formed partially in the longitudinal direction on the left side surface of the bolt main body 730, as shown in FIG. 9.

The toggle member 740 axially rotates based on the rotation shaft 750 inside the bolt main body 730 so as to alternately switch or toggle between a locked state and an unlocked state. As an example, the toggle member 740 has a rectangular shape, is positioned in parallel to the bolt main body 730 in the unlocked state, and is positioned to form a predetermined angle θ with respect to the bolt main body 730 by rotating around the rotation shaft 750 in the locked state.

As the nut 722 is tightened, the spring washer and the flat washer 723, 724 lower along the thread of the bolt main body 730. Accordingly, the spring washer and the flat washer 723, 724 rotate the toggle member 740.

When unlocking the smart toggle bolt 700, the unlocking adjustment pin 710 is inserted into the adjustment pin insertion groove 721a. By inserting the unlocking adjustment pin 710 into the adjustment pin insertion groove 721a, lowering the unlocking adjustment pin 710, and rotating the toggle member 740, the locked state is toggled to the unlocked state. The unlocking adjustment pin 710 is inserted into the adjustment pin insertion groove 721a and passes through the through nut 722 and the spring washer and the flat washer 723, 724 in the downward direction, thereby rotating the toggle member 740.

In explaining the present invention, explanations may be omitted for matters that would be obvious to those skilled in the art and prior art may be omitted, and description of these omitted components (methods) and functions may be sufficiently referenced without departing from the technical spirit of the present invention. In addition, the components of the present invention described above are only explained for the convenience of explaining the present invention and components not described herein may be added without departing from the technical spirit of the present invention.

The description of the features and function of each part described above is explained separately from each other for convenience of explanation, and if necessary, any one feature and function may be implemented by integrating with other components, or may be implemented in further detail.

The present invention has been described with reference to embodiments hereinabove, but the present invention is not limited thereto and various modifications and applications are possible. That is, those skilled in the art could readily understand that many modifications are possible without departing from the gist of the present invention. In addition, it should be noted that if a detailed description of known functions and configurations related to the present invention or coupling relationships between each component of the present invention is judged to unnecessarily obscure the gist of the present invention, the detailed description thereof has been omitted.

### EXPLANATION OF REFERENCE SIGNS

1: smart toggle bolt
100: bolt main body
200: housing
300: toggle member
400: nut
500: washer
700: smart toggle bolt
710: unlocking adjustment pin
721: height adjustment bolt
721a: Adjustment pin insertion groove
722: nut
723: spring washer
724: flat washer
730: bolt main body
731: first rotation slit
732: second rotation slit
740: toggle member
750: rotation shaft

What is claimed is:

1. A smart toggle bolt used to fix a bracket to a structure, comprising:
a bolt main body inserted into through holes formed in a structure and a bracket;
a toggle member fastened to a lower end of the bolt main body so as to rotate eccentrically;
a housing fastened to the lower end of the bolt main body so as to slidingly move in a longitudinal direction of the lower end; and
a rotation shaft, which is biased to one side based on a long axis of the bolt main body so as to be formed eccentrically,
wherein according to sliding movement of the housing, the toggle member rotates eccentrically by the rotation shaft, alternating or toggling between a locked state and an unlocked state so as to secure the bracket to the structure.

2. The smart toggle bolt according to claim 1, wherein
the bolt main body includes
a cylindrical upper end portion,
a middle portion, which extends from the upper end portion and has a thread formed on an outer peripheral surface, and
a cylindrical lower end portion, which extends from the middle portion, has a sliding slit formed on at least one side in a longitudinal direction of the body so that a cross-section is formed in a U-shape open to the right, and has a diameter larger than those of the upper end portion and the middle portion.

3. The smart toggle bolt according to claim 2, wherein
the housing includes
a cylindrical housing main body fastened to the outside of the lower end portion, and
a locking member, which extends from one side of the lower end of the housing main body, of which a portion is inserted inside the sliding slit and moves along the sliding slit so as to press one surface of the toggle member, and which restricts movement of the housing in one direction.

4. The smart toggle bolt according to claim 3, wherein
the toggle member is provided in a trapezoidal shape such that
length of an upper side is equal to diameter of the lower end portion,
length of a lower side is greater than the diameter of the lower end portion, and
height is equal to the diameter of the lower end portion, and
has a hole formed in the center so as to be axially coupled to the rotation shaft through the through hole,
the upper side is positioned inside the bolt main body according to the eccentric arrangement of the rotation shaft, and the lower side passes through the sliding slit and is positioned outside the bolt main body.

5. The smart toggle bolt according to claim 3, wherein
if the housing is in a lowered state, the toggle member is pressed by the locking member that comes into contact with the upper side of the toggle member so that the upper side and the lower side are fixed in a direction parallel to the longitudinal direction of the bolt main body so as to maintain the unlocked state, and
as the housing rises, pressing restraint force of the locking member that is in contact with the upper side is gradually weakened and the toggle member is rotated by the rotation shaft so that the upper side and the lower side are spread in a direction perpendicular to the longitudinal direction of the bolt main body so as to maintain the locked state.

6. The smart toggle bolt according to claim 5, wherein when the locking member has risen to maximum height and comes into contact with an inner surface of the sliding slit, the pressing restraint force by the locking member is released and the upper side and the lower side of the toggle member are spread in the direction perpendicular to the longitudinal direction of the bolt main body so as to maintain the locked state.

7. The smart toggle bolt according to claim 1, wherein the toggle member has a trapezoidal shape in which both hypotenuses formed between the upper side and the lower side are formed to have stepped inclination structures and anti-slip members are provided on surfaces of the stepped inclination structures.

8. A smart toggle bolt, comprising:
a bolt main body, which is inserted into through holes formed in a structure and a bracket and has a thread formed in a longitudinal direction;
a height adjustment bolt, which is formed with a thread in a longitudinal direction of a body, adjusts height by being threaded to the inside of the bolt main body, and has an adjustment pin insertion groove formed in the longitudinal direction on one side;
a toggle member, which is coupled to the bolt main body and rotates around a rotation shaft; and
an unlocking adjustment pin, which is inserted along the adjustment pin insertion groove of the height adjustment bolt and rotates the toggle member so that the toggle member axially rotates by the rotation shaft so as to unlock the bracket from the structure.
